(19) United States
(12) Patent Application Publication
(10) Pub. No.: US 2025/0298493 A1
(43) Pub. Date: Sep. 25, 2025

(54) SYSTEM AND METHOD FOR INDIVIDUAL OR GROUP CHAT MESSAGING CONTAINING ORGANIZED TOPICS AND EVENTS ON THE SAME SCREEN

(71) Applicant: Sircles Media, Inc., Sacramento, CA (US)

(72) Inventors: Todd Fiore, Roseville, CA (US); John Worthington, Fair Oaks, CA (US)

(21) Appl. No.: 19/087,161

(22) Filed: Mar. 21, 2025

Related U.S. Application Data
(60) Provisional application No. 63/568,330, filed on Mar. 21, 2024.

(51) Int. Cl. G06F 3/0482; G06F 3/04817; G06F 9/451; H04L 51/214

(52) U.S. Cl. CPC G06F 3/0482; G06F 3/04817; G06F 9/451; H04L 51/214

(57) ABSTRACT

A chat/group messaging method and system has an “app” with a user interface for a smart device connected to a server. A client-side group chat app is installed on the smart device and a server-side group chat application on the server. The method/system enables the display of at least one of topic of interest, a contact list, and a group chat, for user selection; and to receive via the user interface, the user selection. Next, the app displays on at least one of a target contact and a target group chat, based on the user selection, for user followup selection. Upon user followup selection, the app forwards selected information to the at least one target contact and target group chat. The method/system enable easy group chat creation and management for diverse subjects, with minimal menuing and increases the utility of mobile communications.

### CROSS-REFERENCE TO RELATED APPLICATION(S)

This non-provisional application claims the benefit and priority of U.S. Provisional Patent Application No. 63/568,330, filed Mar. 21, 2024, the contents of which are hereby incorporated by reference in its entirety.

### FIELD

This invention is directed to the area of individual text messaging and group chat text messaging, particularly for devices such as smart phones.

### BACKGROUND

In today's digital landscape, users demand seamless communication and content-sharing experiences within chat messages. Whether it's sharing entertainment options, discovering new places, or sparking conversations with custom topics, users are actively seeking intuitive and efficient platforms to engage with their peers and cultivate meaningful discussions around shared interests. Current implementations of individual text messaging and group chats are either very limited or far too cumbersome and display-space inefficient. Therefore, with limited screen space on a user's device, implementing a cogent and efficient design of user-group chat interaction is much desired.

### SUMMARY

The following presents a simplified summary in order to provide a basic understanding of some aspects of the claimed subject matter. This summary is not an extensive overview and is not intended to identify key/critical elements or to delineate the scope of the claimed subject matter. Its purpose is to present some concepts in a simplified form as a prelude to the more detailed description that is presented later.

In a brief non-binding summary, various embodiments of the exemplary app address the diverse communication and content-sharing needs of its users within messaging environments (most evident in mobile communication capable devices). By prioritizing seamless user experiences, enhancing engagement mechanisms, and nurturing meaningful interactions, the exemplary app empowers users to forge deeper connections, explore shared interests, and seamlessly share content with their peers.

In one aspect of the disclosed embodiments, a system of generating, organizing and sharing topics for a group chat session and navigating the group chat session is provided, comprising: a smart device with a user interface, a display and an internal processor, with communication capabilities to a server; a client-side group chat app installed on the smart device and a server-side group chat application running on the server, supporting the client-side group chat app; a computer-readable medium having encoded thereon computer-executable instructions to cause at least one of the smart device and server to: display on the smart device's display at least one of topic of interest, a contact list, and a group chat, for user selection; receive via the user interface, the user selection; display on the smart device's display at least one of a target contact and a target group chat, based on the user selection, for user followup selection; receive via the user interface, the user followup selection; and forward selected information from the user selection to the at least one target contact and target group chat from the user followup selection.

In another aspect of the disclosed embodiments, the above system is provided, further comprising computer-executable instructions to have the displayed group chat include an option to create a new group chat; and/or further comprising computer-executable instructions to have the displayed contact list include an option to select a contact within at least one of the client-side group chat app and software native to the smart device; and/or further comprising computer-executable instructions to message a non-client-side group chat app contact with a subset of selected information from the user selection; and/or wherein a preview of a selected topic of interest is forwarded; and/or further comprising computer-executable instructions to search for a topic of interest within the client-side group chat app; and/or further comprising computer-executable instructions to display at least one of a last comment and relevant comment for a forwarded topic of interest within the client-side group chat app; and/or further comprising computer-executable instructions to display on a single screen of the smart device, a contact-related icon, a places-related icon, an entertainment-related icon, and a new topic-related icon, upon user selection of the group chat; and/or further comprising computer-executable instructions to display a new topic fill-in screen, upon user selection of the new topic-related icon; and/or further comprising computer-executable instructions to display a focusable list on the smart device's display, the list having icons showing a user-participating chat, a topic, and an event; and/or further comprising computer-executable instructions wherein a selection of the topic icon creates a new topic window if there are no current topics, and a new event window if there are not current events; and/or wherein the computer-executable instructions forward user selected information within a three screen sequence on the smart device.

In yet another aspect of the disclosed embodiments, a method of generating, organizing and sharing topics for a group chat session and navigating the group chat session is provided, comprising: displaying on smart device with a user interface, a display and an internal processor, with communication capabilities to a server, at least one of topic of interest, a contact list, and a group chat, for user selection, wherein the smart device has an installed group chat app and the server has a group chat application supporting the smart device's group chat app; receiving at the server via the user interface, the user selection; displaying on the smart device's display at least one of a target contact and a target group chat, based on the user selection, for user followup selection; receiving via the user interface, the user followup selection; and forwarding selected information from the user selection to the at least one target contact and target group chat from the user followup selection.

In yet another aspect of the disclosed embodiments, the above method is provided, further comprising including a displayed option to create a new group chat; and/or further comprising including a displayed option to select a contact within at least one of the client-side group chat app and software native to the smart device; and/or further comprising messaging a non-client-side group chat app contact with a subset of selected information from the user selection; and/or further comprising forwarding a preview of a user selected topic of interest; and/or further comprising providing a search bar for a topic of interest within the client-side group chat app; and/or further comprising displaying at least one of a last comment and relevant comment for a forwarded topic of interest within the client-side group chat app; and/or further comprising displaying on a single screen of the smart device, a contact-related icon, a places-related icon, an entertainment-related icon, and a new topic-related icon, upon user selection of the group chat; and/or further comprising displaying a new topic fill-in screen, upon user selection of the new topic-related icon; and/or further comprising displaying a focusable list on the smart device's display, the list having icons showing a user-participating chat, a topic, and an event; and/or further comprising creating, upon a user selection of the topic icon, a new topic window if there are no current topics, and a new event window if there are not current events; and/or further comprising forwarding user selected information within a three screen sequence on the smart device.

### BRIEF DESCRIPTION OF THE DRAWINGS

FIG. 1 is an illustration of sample hardware support system for an exemplary implementation.

FIG. 2A is a flow-block diagram of an exemplary process, wherein a user having an installed exemplary app wishes to forward a desired content/information to another user.

FIG. 2B is a flow-block diagram of another possible implementation/process of an “add-on” feature prior to sending selected information.

FIG. 3 contains several screen shots demonstrating an implementation of an exemplary app exchange with a user for selecting content to be sent to another user.

FIG. 4 are screen shots showing how a user can choose to add message recipients from a list of other users in the exemplary app and from the user's phone contact list, as well as a list of previous conversations made through the exemplary app screen.

FIG. 5 shows example screen shots of a user moving forward after selecting multiple people they desire to send a message to, compose a new message, and send a message

FIG. 6 shows example screen shots of how a user can navigate on the exemplary app to share content directly into the chat they are currently in.

FIG. 7 shows screen shots summarizing a look and feel of the exemplary app within a group message setting.

FIG. 8 illustrates a series of screen shots for an example of a user creating a custom topic in a group chat.

FIG. 9 shows various screen shots exampling of a user creating an event.

### DETAILED DESCRIPTION

The exemplary method and system, explained in the context of an app below, stands out as a comprehensive solution designed to enrich communication and content sharing within individual text message conversations and group chats. This is particularly relevant given most mobile devices only offer limited display size, thus restricting the amount of viewable information available to a user. Aspects of various embodiments manage well, these limitations to provide the user a comprehensive and efficient sharing experience. For example, several capabilities in various embodiments are described below.

Effortless creating, viewing, organizing and sharing of various topics (people, places, things, entertainment, events, ideas, etc.) using a mobile communication framework is elucidated herein. The exemplary app empowers users to easily visualize and navigate between topics, automatically create topics and to seamlessly share their favorite profiles such as: People, places, entertainment, custom topics, or events, etc. directly within individual text messages and group chats. Leveraging features such as automatic generation of topics based on sharing content profiles or creating new custom topics or events, intuitive recipient selection, dynamic auto-predictive search capabilities, and real-time interaction, the exemplary app simplifies and enhances user engagement. The exemplary app offers a user-friendly and hyper-organized interface coupled with optional customization features, enabling users to effortlessly initiate discussions and share content tailored to their specific interests. The streamlined creation process ensures that users can swiftly generate topics, fostering dynamic interactions and vibrant discussions within text message conversations and group chat environments. Thus, enriching the user's experience and providing rapid traversing of chat topics with ease. It is understood here that the term chat is reference to a messaging format, commonly used in mobile systems or text/video-based communications. [PLEASE PROVIDE A DEFINITION TO EXACTLY CLARIFY “CHAT”] Examples of these one or more approaches to achieve these goals are illustrated in the following FIGS. and explanations.

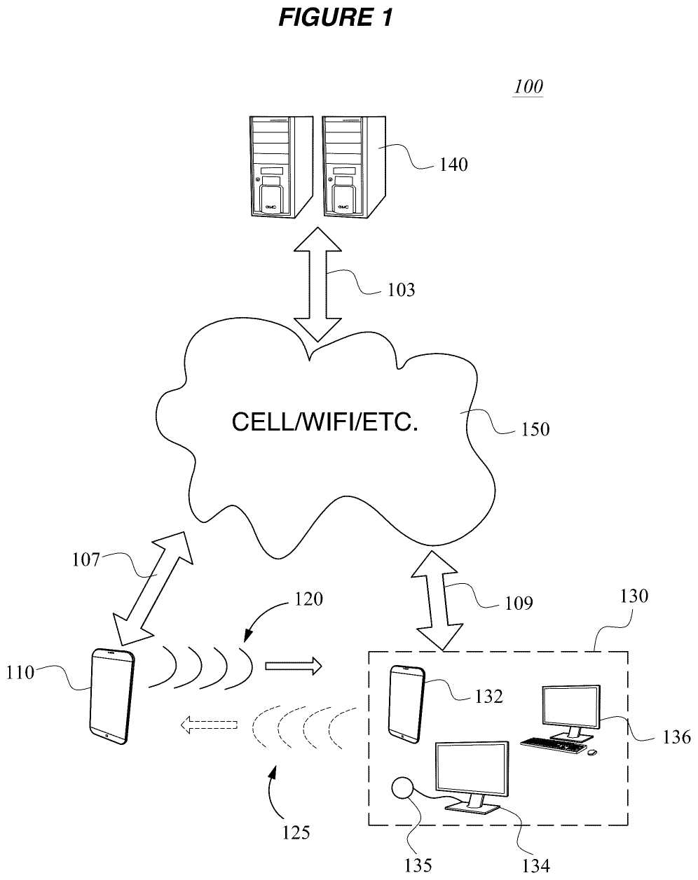

FIG. 1 is an illustration 100 of sample hardware support system comprising one or more servers 140 connected 103 to a communications cloud/network 150 (for example, the Internet and/or Cellular and/or Satellite, etc. systems) with secondary connection 107 to a user's smart device or smart phone 110 running an exemplary embodiment via an exemplary software application/app. The user's smart device or smart phone 110 can be a watch device, glasses device, virtual reality device, notebook or computer, or any communication device capable of performing software execution and interfacing with the user. Network 150 also is connected via link 109 to device(s) 130 of other users, which may include similar mobile devices 132, “pods” 136, physically connected hardware 134 (if desired) and computers 136, etc. Communication between the customer's device 110 can also be facilitated, in some embodiments, directly to other devices 130 (and vice versus) via wireless communication 120/125 or indirectly via link 109.

The servers 140 are loaded with server software that supports the exemplary app that is running on the user's device 110 and also, if installed, on other users' hardware 130. The exemplary app can be downloaded to any one or more methods commonly known in the art. When a user requests for any of the actions described via the exemplary app, the requests are forwarded to the server(s) 140 and processed and then instructions/status(es)/requests/actions forwarded to other users' hardware 130 (or user phone 110), in some cases the former also running a version of the exemplary app if app-to-app communication is possible. As detailed below, in some situations, the “action” requested may alternately be accomplished via the cellular provider's network and system, or via the mobile device's own software. In some embodiments, the requests may be speech driven, eye movement driven, keyboard driven, gesture driven, and so forth.

Implicit in the above FIG. is the understanding that such hardware systems, specifically mobile smart devices 110 will contain computer-like hardware such as a processor, memory, display, communications chip, etc. It is well known that processors may also contain on-chip memory. For larger computer systems, memory will be distributed among hard drives (or an analogous form of external memory—e.g., solid state drives, optical drive, tapes, etc.), the details of which are well known and understood in the industry. In these larger systems, multiple processors may be used and, as the various hardware elements are scaled for higher performance and capabilities, the form factor will also scale upward resulting in the computing device to be tantamount to a desktop computer or server.

As will be appreciated by one skilled in the art, the “mobile hardware” described in FIG. 1 (and by inference to the servers 140, other users' hardware 130 in FIG. 1), will incorporate software components. Accordingly, embodiments of the present disclosure will contain one or more software components (e.g., program code, application, app, firmware, resident software, micro-code, etc.) stored in a tangible computer-readable, non-transitory memory, or removable memory media, or CPU memory, etc. that form a specifically configured apparatus that performs the functions as described herein. One or more of these software functions can be generally referred to herein as “modules”.

The software component portions of the modules or functions, steps, operations that are part of the exemplary process(es), may be written in any computer language and may be a portion of a monolithic code base, or may be developed in more discrete code portions such as is typical in object-oriented computer languages. In addition, the modules may be distributed across a plurality of hardware systems, such as mobile devices, servers, terminals, and the like. A given module may even be implemented such that the described functions are performed by separate processors and/or computing hardware platforms (including phones). In addition, some embodiments of the apparatus may include a tangible computer readable medium containing non-transitory instructions stored therein that when executed by a processing device cause the processing device to implement the methods as described herein.

It is understood that the specific order or hierarchy of steps in the processes disclosed is an example of applicable approaches. Based upon design preferences, the specific order or hierarchy of steps in the processes may be rearranged while remaining within the scope of the present disclosure. Those of skill would further appreciate that the various illustrative logical blocks, modules, and algorithm steps described in connection with the embodiments disclosed herein may be implemented as electronic hardware, computer software, or combinations of both. To clearly illustrate this interchangeability of hardware and software, various illustrative components, blocks, modules, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. A storage medium is coupled to the processor such that the processor can read non-transitory information from, and write non-transitory information to, the storage medium.

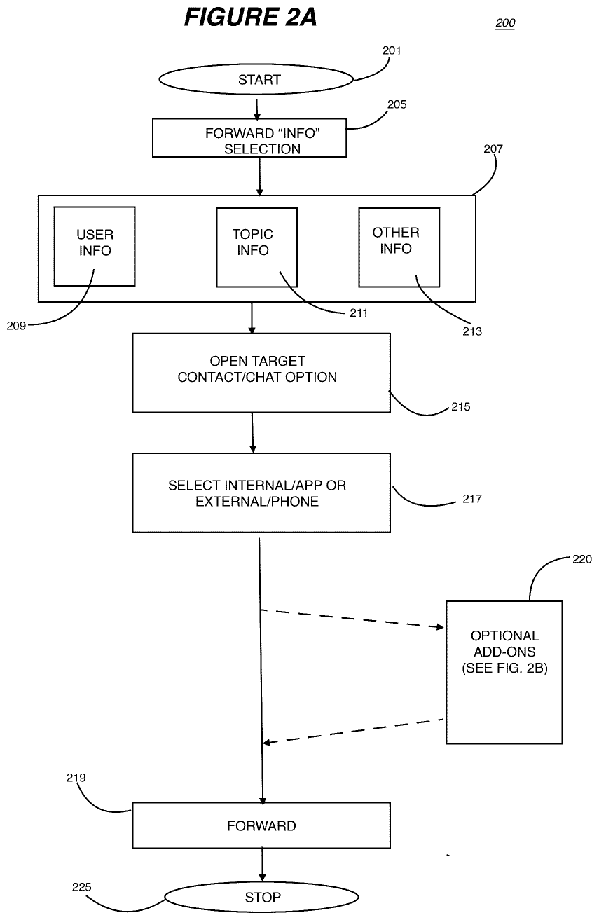

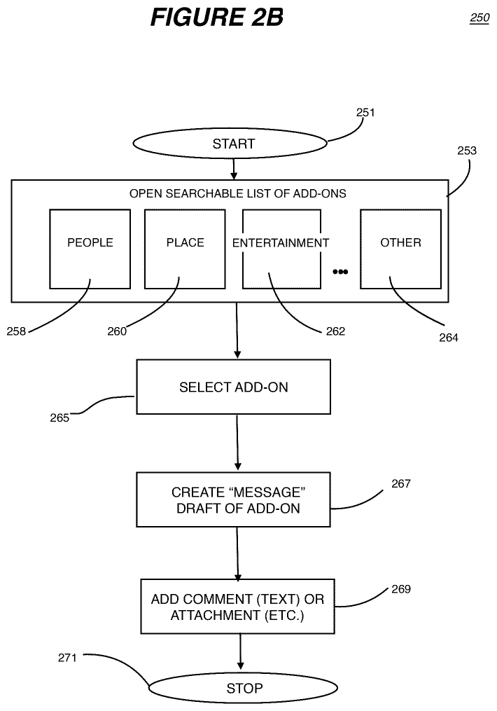

FIG. 2A is a flow-block diagram of an exemplary process 200, wherein a user having an installed exemplary app wishes to forward a desired content/information to another user. The exemplary process 200 starts 201 with the user initiating via an input menu on the user's device/app a selection option 205. A menu of available options 207 is provided having “type” options for at least user information 209 (e.g., the instant user or another user), topic information 211 and other information 213. Typically, the user/other user information will entail a profile or contact information to be forwarded, and the topic information 211 as some media, news, entertainment, or subject of interest. The other information 213 may be a category that is private to the user or is one that is provided (for example, photos, videos, etc. on the user's device), etc. In some instances, topic information 211 and other information 213 may be information from subscriptions that are available in the user's device. Upon selection of the appropriate “type” of information, a menu listing 215 the target user (to receive the selected information) is provided to the user. Commensurate with this step 215 is the ability to open up one or more chats (to create or to join) so that a chat session can be the target of the sent information (thus, multiple users—of a pre-existing chat or of a newly created chat—can receive the information). Since some types of information are locked to the mobile device and not shared, a secondary option 217 is provided to allow mobile-housed information to be selected, as well as exemplary app-provided information. For example, the contact list in a smart phone is local to the smart phone and may not be available to the exemplary app (in some instances). Similarly, a given chat session may be only phone-based, using the cellular network's implementation of a chat (e.g., multiple users) in combination with the phone's software, and not viewable by the exemplary app. Conversely, a given chat session (between users) may be exemplary app-based and communication may be fronted by the exemplary app's interface, and not seen by the phone's internal contact list. Given these platform limitations, various options to enable non-app users to participate in an exemplary app-based chat are described below, as well as allowing exemplary app users to participate in a native to phone-only ecosystem based chat. [IS THIS LAST PHRASE TRUE?]

Continuing, the exemplary process 200 can have an optional “add-on” function, as further described in FIG. 2B. Next, the process 200 forwards the selected information to a user(s) and/or chat. And stops 205.

FIG. 2B describes one possible implementation/process 250 of an “add-on” feature prior to sending selected information. The implementation/process 250 starts 251 wherein a searchable list of add-on options 253, having at least one of people/contacts 258, place 260 (having, if so desired, a geo-location or proximity filter), entertainment 262, and additional “other” 264 options (to be decided by the user and/or the app developer) are provided to the user. The user then selects 265 from the options list 253, where in some embodiments, the selection can be highlighted or shadowed in the display's header (indicating the current focus). Next, the user can be given the option to add a message or text 267 to the selected add-on, and then a window or text-input line(s) 269 is provided. Of course, the text-input line 269 can have an option to add non-text information, such as emojis, photos, sound, video, etc. The process 250 returns 271 to the forwarding step 219 of FIG. 2A. This add-on approach 250 enables, for example, a user to first select a target a contact or a chat, and thereafter add content to that targeted person(s) or conversation, or to add additional content (e.g., information) to the information that was first selected in the process of FIG. 2A.

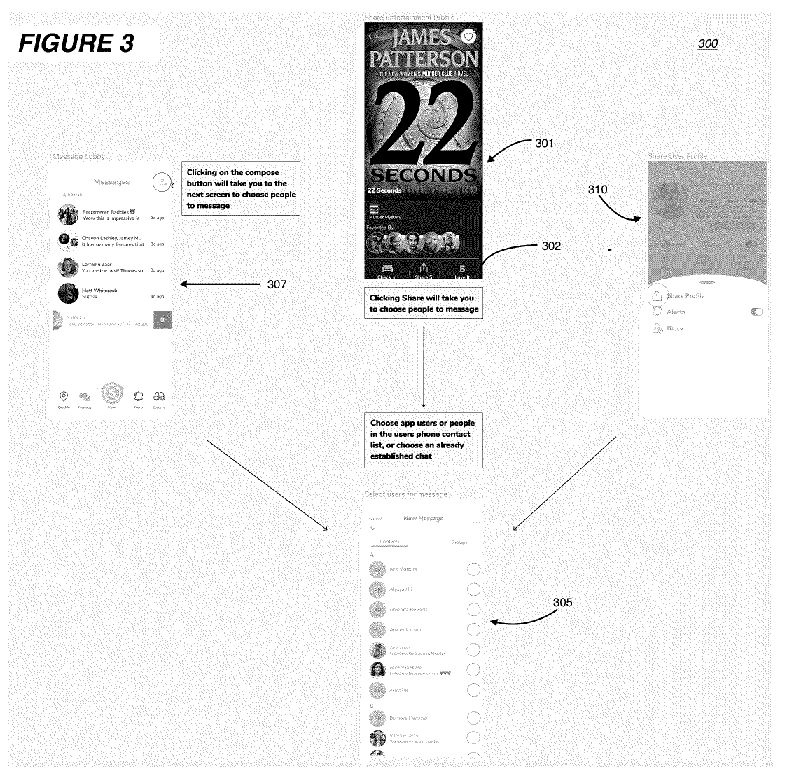

Various approaches of the above are demonstrated in the following screen shots. For example, in FIG. 3, several content, interest or activities can be managed through a simple series of user operations. All within minimal screens and operations, as exampled in a mobile phone environment. In one scenario, shown at the top of FIG. 3, a topic (i.e., topic information/content) such as a James Patterson novel “22 Seconds” 301 may be prompted to (or searched upon by) a user. And if the user is interested in sharing this topic or material to another user or group or chat, they can “click” or activate a share option on the screen (shown here as button menu 302 but may be any other button(s) or section of the display, as well as an audio command, haptic motion, etc.). If the target is another user, then a contact list 305 is opened for selection of the desired contacts. After selection, a screen or other option 310 is initiated for confirmation and sending action, to forward the James Patterson novel “22 Seconds” 301 information to the selected person(s).

If the button menu 302's chat option is selected, then a list of previous, or continuing messages/chats 307 is displayed (e.g., a message lobby), with an option to also create a new chat if desired. Upon selection/creation of a chat(s), the system can similarly offer (if so desired) a “send” confirmation step as demonstrated in 310, to forward the James Patterson novel “22 Seconds” 301 information to the selected chat(s).

It is understood here that in the first example above, a user's profile is being shared toother user(s). In this profile-sharing scenario, the share action can open to a selection of people or friends or contacts, etc. to share the topic, either on the current platform or with another platform. The other contacts also can be from the user's own phone contacts or with an individual, an established group or chat. The choice of path, as shown here via accessing a share button on various content profiles, can be made by any number of user-interface actions, such as a long press versus a short press, or a menu, a modal, a drawer or pop-up, etc. All triggered by a “button” or option shown to the user on this device.

FIG. 3 also by implication shows a 3rd option, wherein instead of beginning with James Patterson's novel “22 Seconds” 301, the user is afforded a message lobby 307 that shows all previous conversations. When a user clicks to compose a chat, they can be prompted to choose people to add to an existing conversation or for a new conversation. These can be conversations with, for example, a group of 2 or more people and some of whom may not even have the exemplary app installed but receive a message shared as a text message in their phone. This interface allows the user to compose a new conversation as well as, if desired, delete previous conversations. To enable quick searching for previous conversations, names of group conversations, individuals, words or phrases in conversation, etc., some form of a search bar can be provided.

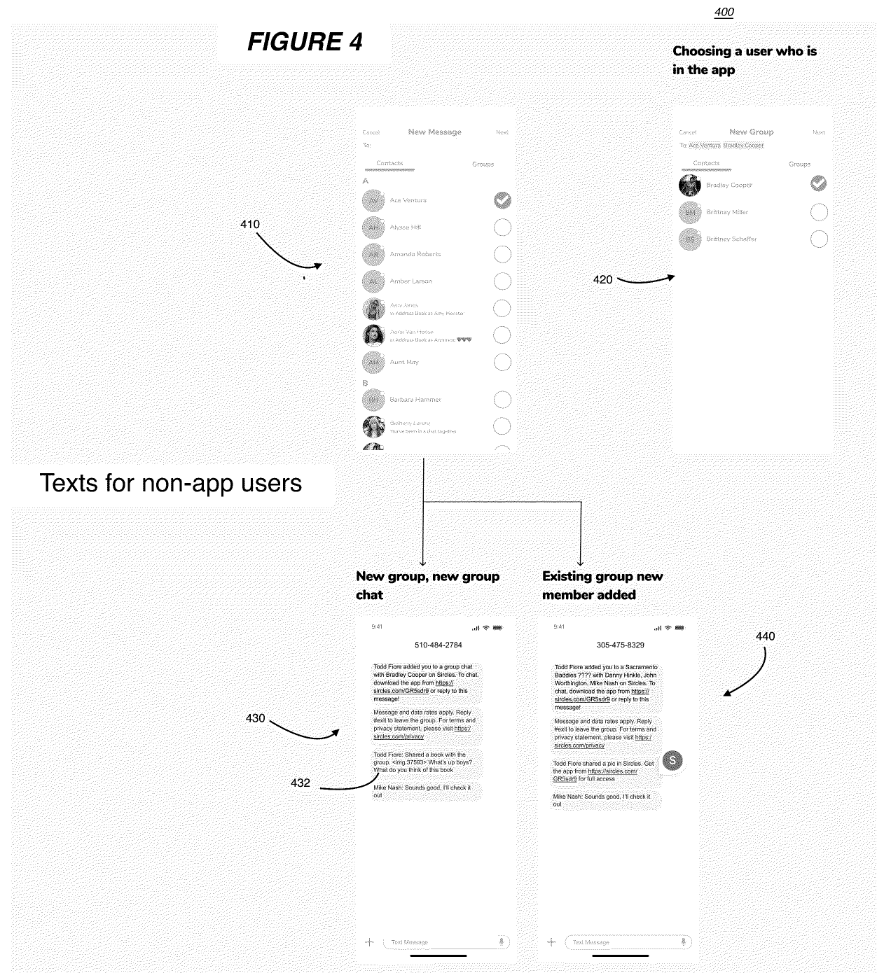

FIG. 4 are screen shots 400 showing how a user can choose to add message recipients from a list of other users in the exemplary app and from the user's phone contact list 410, as well as a list of previous conversations made through the exemplary app screen 420. This adds a wider range of people to message and share favorites with and still include friends even if they don't have the exemplary app installed (e.g., external users). Screen shot 430 shows an example of a text message received by an external user by way of a new group/new group chat being hosted on the exemplary app (seen here as Sircles), wherein the recipient is offered an opportunity to download the exemplary app (Sircles). A summary or phone-friendly version of the exemplary app's message is provided to the non-app user's phone. Screen shot 440 shows a similar message but for an already established named group chat that has invited a new person into the group.

In various embodiments, people who are not in the exemplary app (e.g., external users) will continue to receive text messages of the conversation. To conform with privacy and “new” user acceptance, the initial text message an external user receives in the text message conversation of the group chat they are being invited to can be one or more of: an opt-out option to be removed from the group chat, a link to download the exemplary app, and all disclosures for participating in the exemplary app, and links to Terms of Service and Privacy Policy. This gives the external user, who is not yet in the exemplary app, consent to participate in the group chat. In some embodiments, unless they opt-out or download the exemplary app, they will receive a text every time a message is sent in the group chat.

In some optional scenarios, the exemplary app can suggest to the user who is interested in sharing his/her topic to other people whether non-friend or external users who may be of interest to connect with—from the user's perspective. Entry of other suggested users can be presented from the exemplary app by location to current user, number of comments on associated topics, relevance (for example, a user may have been a moderator of a group dedicated to the topic), and so forth. Other non-limiting examples are notifications based on ranking of volume (e.g., a specific topic that is trending, “likes” by a particular person regarding that topic, etc.) or ranking based on the user's interest as compared to other users sharing the same interest or similar. In some instances, a location+topic (interest)+time metric may be used, where a “near” user having a common interest (or topic) shares or comments on the topic within a defined time period. For example, if the current user is near to a given restaurant, the exemplary app may trigger a notification that another user who just finished eating there recently shared their opinion. This can help a user in proximity to the restaurant be aware of wait times, specials of the day and so forth.

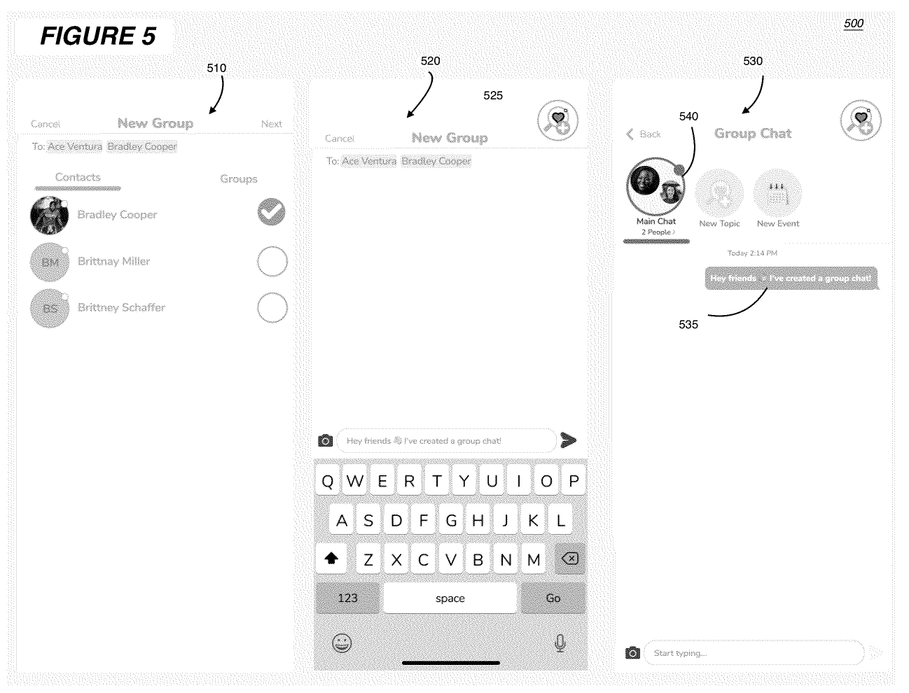

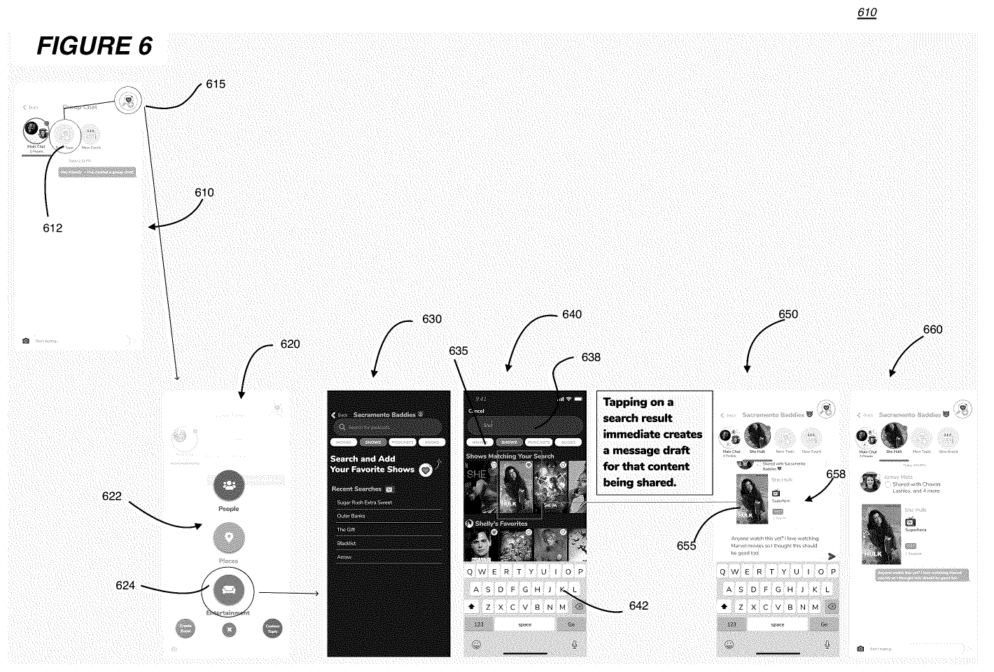

FIG. 5 shows example screen shots 500 of a user moving forward though screens after selecting multiple people they desire to send a message to 510, composing a new message 520 (for a group), and a sent message 535 within the group chat screen 530. When a message is composed, it can be shared via a favorites share button 525. They also have the option to create/share a topic during this process (see FIG. 6 example). Once they click send, the chat is automatically created as are any topics that were shared. Multiple topics can be featured in the display, with the selection “focus” via highlight. Highlights may take the form of a unique color, shape, underscore slider, an “orbit” with enlarged “satellite” 540, etc.

FIG. 6 shows example screen shots 600 of how a user can navigate on the exemplary app to share content directly into the chat they are currently in. In this example, screen shot 610 shows a series of user-initiated “touches” or action for sharing an entertainment content profile (a predefined category or one created by the user) by clicking on the “New Topic” button 612 and then the (favorites) “Share” button 615. A subsequent Topic menu 622 is opened having an Entertainment icon 624 as an option, seen in the second screen shot 620. Selecting the Entertainment icon 622 takes the user to a search window 630 for the type of entertainment content they are looking for (having different categories—located in this example at the header 635 of the screen—also having a search bar 638). The user can select a pre-determined category or do a manual search. As seen in the 3rd screen shot 640, the user clicked on the search bar 638 and the keyboard 642 became available for use. Searches can be dynamic auto-predictive, verbal commands, amongst other standard search options (e.g., featuring sponsored, discounted, of particular interest of month, randomized, etc.). The 4th screen shot 650 shows that tapping on a result (She Hulk, in this example in screen shot 640) automatically inserts that entertainment content 655 into a compose window 658 allowing the user to draft a message, if so desired. The entertainment content 655 can be a preview or link to a more expansive “page,” as commonly seen in the industry. This default share message can be offered to expedite the sharing to others, having for example embedded links, information, etc. The last screen shot 660 shows an example of a sent user-generated-topic group chat message. Once the message is sent the topic is created and a card or other type of preview of the profile is shared along with an optional custom message.

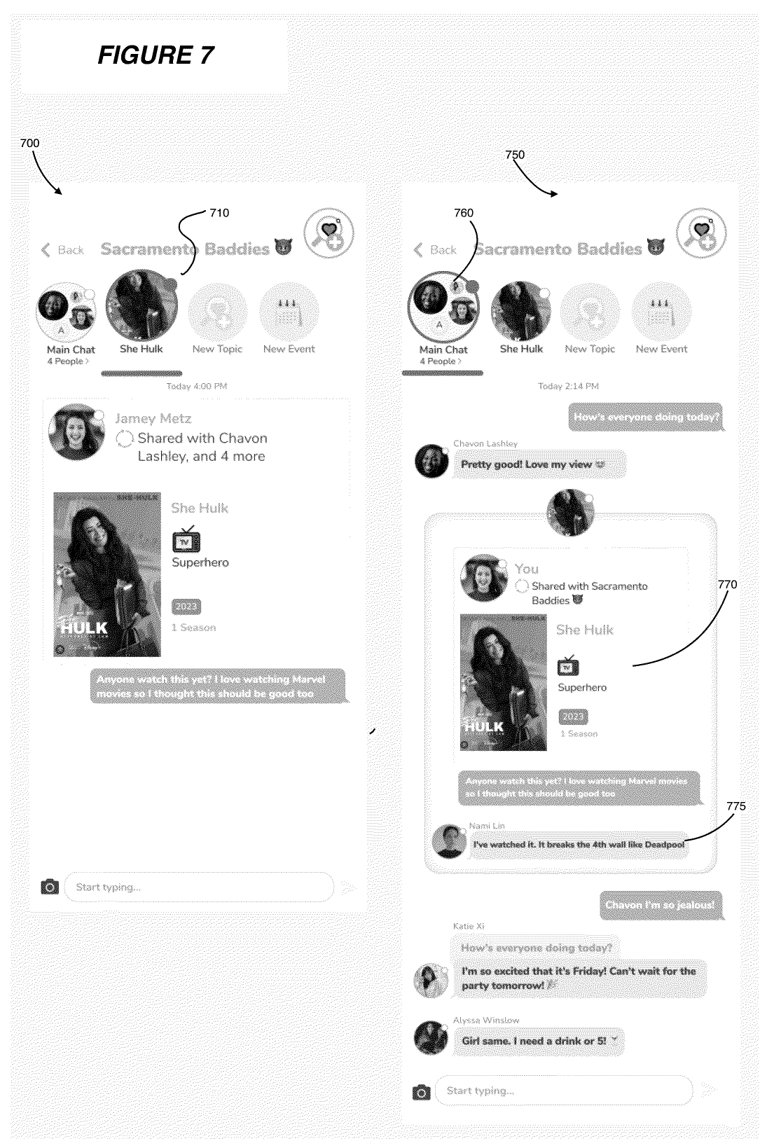

FIG. 7 shows screen shots summarizing a look and feel of the exemplary app. Screen shot 700 shows a selected topic (She Hulk) shared with a pre-existing chat “Sacramento Baddies” and screen shot 750 shows subsequent responses by in-chat users. The process, once the topic is created, it provides an organized place where people can engage conversations around the content profile that was shared or simply message from within the main group chat (not under any specific topic). As seen in screen shot 700, the user can see they are in a specific topic based on the representation of the topic highlighted 710 in some way which may include a special color, a slider, and/or enlarged thumbnail, a filled in dot, etc. As seen in screen shot 700, the user can easily access the main chat by clicking the main chat icon 760 which will display a distinct preview 770 of any recent topic chat conversation 775 happening within the group's other topics. Clicking on topic preview 770 may navigate the user to that topic.

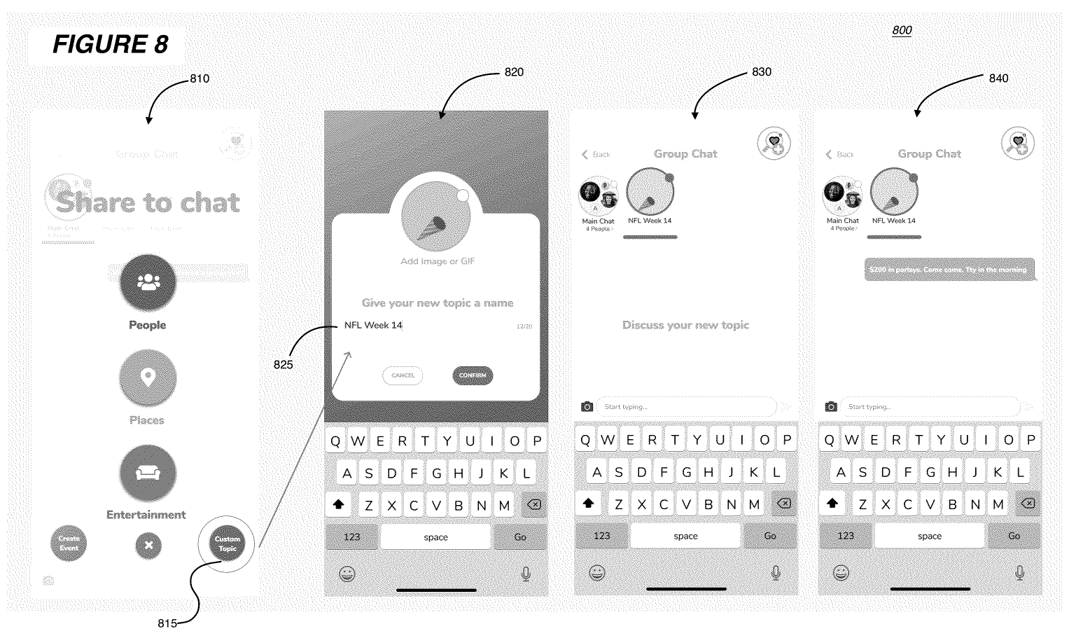

FIG. 8 illustrates a series 800 of screen shots for an example of a user creating a custom topic 815 in a group chat (screen shot 810) by adding information such as name 825 (screen shot 820) and image for the custom topic (not shown). Once the user proceeds they will be taken to a screen (screen shot 830) ready to draft a message. The custom topic is automatically created and displayed in the group chat (screen shot 840).

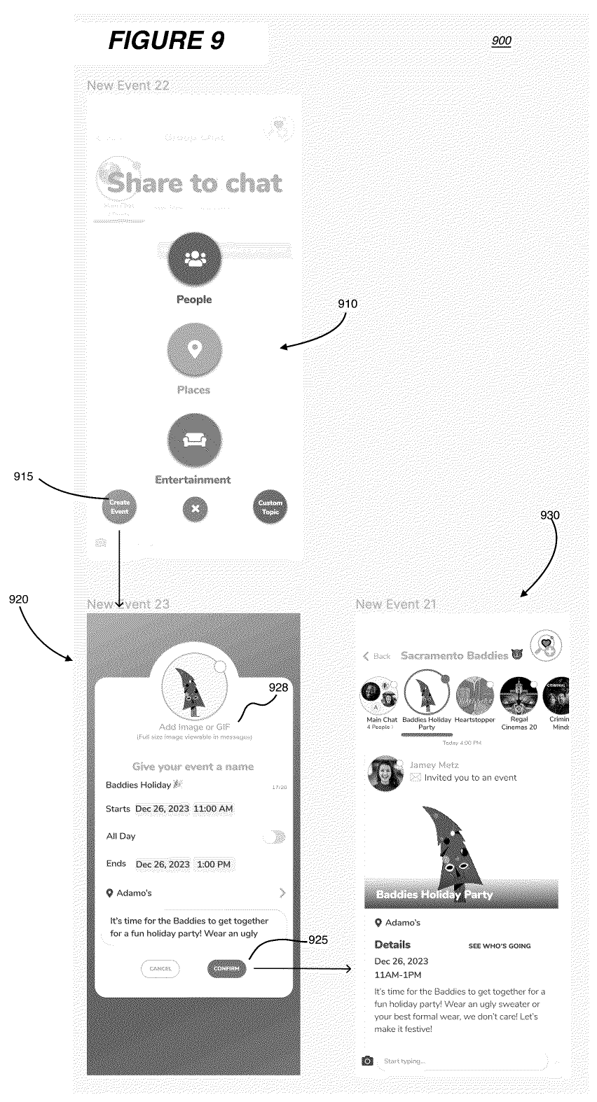

FIG. 9 shows various screen shots 900 exampling of a user creating an event 915 (screen shot 910) as another form of custom topic. The event details include but are not limited to people, places, entertainment, time, date, location, description, and picture, video, animation or gif, and will include a calendar form (screen shot 920) that the user can fill out. The user may be offered the option 928 to import a photo/video/gif, etc. as part of the group message invitation. Subsequent to creating the event, the user can post it to a selected chat or users as seen in screen shot 930.

As can be apparent from the above, viewing, sharing and organizing content and events into topics contained neatly on one screen utilizing text and group chat messaging can be easily formulated, created, navigated, and sent to others using the mechanisms and methods described above. These approaches are particularly advantageous given the small size of phone screens, wherein ease and efficiency is highly desired. Though the above examples are presented in the context of a phone app, it is understood that other devices that rely on messaging or use messaging may also be used, for example a smart tablet, or even a laptop. Further, aspects of the above may be available to a web browser serving as an app analog. Therefore, while specific embodiments of the present invention have been shown and described, it should be understood that other modifications, substitutions and alternatives are apparent to one of ordinary skill in the art

What is claimed is:

1. A system of generating, organizing and sharing topics for a group chat session and navigating the group chat session, comprising:
a smart device with a user interface, a display and an internal processor, with communication capabilities to a server;
a client-side group chat app installed on the smart device and a server-side group chat application running on the server, supporting the client-side group chat app;
a computer-readable medium having encoded thereon computer-executable instructions to cause at least one of the smart device and server to:
display on the smart device's display at least one of topic of interest, a contact list, and a group chat, for user selection;
receive via the user interface, the user selection;
display on the smart device's display at least one of a target contact and a target group chat, based on the user selection, for user followup selection;
receive via the user interface, the user followup selection; and
forward selected information from the user selection to the at least one target contact and target group chat from the user followup selection.

2. The system of claim 1, further comprising computer-executable instructions to have the displayed group chat include an option to create a new group chat.

3. The system of claim 1, further comprising computer-executable instructions to have the displayed contact list include an option to select a contact within at least one of the client-side group chat app and software native to the smart device.

4. The system of claim 3, further comprising computer-executable instructions to message a non-client-side group chat app contact with a subset of selected information from the user selection.

5. The system of claim 1, wherein a preview of a selected topic of interest is forwarded.

6. The system of claim 1, further comprising computer-executable instructions to search for a topic of interest within the client-side group chat app.

7. The system of claim 1, further comprising computer-executable instructions to display at least one of a last comment and relevant comment for a forwarded topic of interest within the client-side group chat app.

8. The system of claim 1, further comprising computer-executable instructions to display on a single screen of the smart device, a contact-related icon, a places-related icon, an entertainment-related icon, and a new topic-related icon, upon user selection of the group chat.

9. The system of claim 8, further comprising computer-executable instructions to display a new topic fill-in screen, upon user selection of the new topic-related icon.

10. The system of claim 1, further comprising computer-executable instructions to display a focusable list on the smart device's display, the list having icons showing a user-participating chat, a topic, and an event.

11. The system of claim 10, further comprising computer-executable instructions wherein a selection of the topic icon creates a new topic window if there are no current topics, and a new event window if there are not current events.

12. The system of claim 1, wherein the computer-executable instructions forward user selected information within a three screen sequence on the smart device.

13. A method of generating, organizing and sharing topics for a group chat session and navigating the group chat session, comprising:
displaying on smart device with a user interface, a display and an internal processor, with communication capabilities to a server, at least one of topic of interest, a contact list, and a group chat, for user selection, wherein the smart device has an installed group chat app and the server has a group chat application supporting the smart device's group chat app;
receiving at the server via the user interface, the user selection;
displaying on the smart device's display at least one of a target contact and a target group chat, based on the user selection, for user followup selection;
receiving via the user interface, the user followup selection; and
forwarding selected information from the user selection to the at least one target contact and target group chat from the user followup selection.

14. The method of claim 13, further comprising including a displayed option to create a new group chat.

15. The method of claim 13, further comprising including a displayed option to select a contact within at least one of the client-side group chat app and software native to the smart device.

16. The method of claim 15, further comprising messaging a non-client-side group chat app contact with a subset of selected information from the user selection.

17. The method of claim 13, further comprising forwarding a preview of a user selected topic of interest.

18. The method of claim 13, further comprising providing a search bar for a topic of interest within the client-side group chat app.

19. The method of claim 13, further comprising displaying at least one of a last comment and relevant comment for a forwarded topic of interest within the client-side group chat app.

20. The method of claim 13, further comprising displaying on a single screen of the smart device, a contact-related icon, a places-related icon, an entertainment-related icon, and a new topic-related icon, upon user selection of the group chat.

21. The method of claim 20, further comprising displaying a new topic fill-in screen, upon user selection of the new topic-related icon.

22. The method of claim 13, further comprising displaying a focusable list on the smart device's display, the list having icons showing a user-participating chat, a topic, and an event.

23. The method of claim 13, further comprising creating, upon a user selection of the topic icon, a new topic window if there are no current topics, and a new event window if there are not current events.

24. The method of claim 13, further comprising forwarding user selected information within a three screen sequence on the smart device.
